(19) United States
(12) Patent Application Publication
(10) Pub. No.: US 2014/0108135 A1
(43) Pub. Date: Apr. 17, 2014

(54) SYSTEM AND METHOD TO EVALUATE, PRESENT, AND FACILITATE THE ADVERTISEMENT AND PURCHASING OF PRODUCTS AND SERVICES BASED ON THE EMOTION EVOKED IN A RECIPIENT UPON RECEIPT OF THE PRODUCT OR SERVICE

(71) Applicant: TECH 4 PROFIT LLC, Austin, TX (US)

(72) Inventor: Sheri K. Osborn, Austin, TX (US)

(73) Assignee: Tech 4 Profit LLC, Austin, TX (US)

(21) Appl. No.: 13/653,845

(22) Filed: Oct. 17, 2012

(51) Int. Cl. G06Q 30/06

(52) U.S. Cl. CPC G06Q 30/0631
USPC 705/14.49; 705/26.62

(57) ABSTRACT

A method of quantifying and attaching the emotional state of receiving a product or service purchased online so that a buyer who lacks history with a particular product or service can be assured of satisfaction with by that product or service because of emotional satisfaction ratings from all purchasers of the same demographic, which also provides advertisers great feedback on the likelihood of advertising of that product to that demographic leading to a product purchase so therefore generating an advertising fee based on the ranking of emotional state change each product/service provides the end user.

### BACKGROUND OF THE INVENTION

There have been many studies to understand buying behavior. These studies are based around neuroscience, the psychology of the buying process and market research. Satisfaction with a buying decision is highly influenced by emotional impact. Students in marketing, advertising and sales training are repeatedly trained to sell benefits not features.

So far, the science of buying behavior tells us that people have developed a few strategies to aid in their buying process most of which are based on their information processing capabilities (what they can see and learn) or what they already know (historical).

When walking around a department store, a buyer can go to a toy department and choose from the toys they see in front of them. They make a series of comparisons based on a variety of indicators such as how much they want to spend, their own preferences (such as avoiding violence) then narrow all of the items to the one they purchase. This process is boiled down to choosing from a list of known alternatives which is useful when you are in a department store and can walk through the toy department.

The next option a buyer may choose is from their known experience. According to Lynch, Marmorstein and Weigold, many shopping tasks are performed by historical data such as seeing a few televisions in one store at a mall then buying one of them from a different store. Or consumers may use a positive experience with the brand such as always choosing to stay at an Embassy Suites Hotel® (a registered trademark of Hilton Hospitality, Inc.) because of past experience with Embassy Suites Hotel®.

Another strategy is to choose from what the buyer understands of the recipient's experience. For example, if a buyer has purchased a similar item for a different person and achieved the desired emotional response, then it stands to reason that the same item may elicit a similar response for a demographically similar recipient.

Similarly a buyer could seek for the recipient to get the same emotional response that the buyer received from a similar purchasing experience. The similar purchasing experience is shaped by each recipient's emotional make up, culture and background as well as the various features of the products. All actions and processes that are involved, such as physical actions and perceptual and cognitive processes (e.g., perceiving, exploring, using, remembering, comparing, and understanding), will contribute to the buying decision which presumes that the intended recipient for a purchase thinks, feels and processes information similarly to the buyer.

The obvious problem occurs if the purchaser has different demographics from the recipient (e.g. the purchaser is a different gender or does not have experience with the products for a particular demographic). For example, a grandparent needs to buy a gift for a 10 year old. Many of the current electronic toys and Internet games were not available during the childhood of the grandparent so the grandparent has little basis for making a buying decision.

This task becomes even more daunting when the purchase is from an e-tail store site (e.g. an internet based retailer). Upon entering an e-tail site, users typically are offered a few advertisements of that site's specials or new arrivals and more sophisticated sites offer alternatives based on the user's personal buying preferences or random selections. Otherwise, the user is provided a blank “search” box which means:

The user must have a good idea of what they are shopping for before they use the e-tail site.

There is not a feature to help them understand a particular demographics' response to this or that item except perhaps reading reviews hoping to glean feedback from a similar demographic after they select a product.

The user needs an easy way to be able to enter the demographic of the purchase and the emotional response desired and be provided with a selection of all products and services available at the e-tail site that have a proven record of a similar response from that particular demographic.

Therefore, there is a need for a solution which addresses these and other shortcomings of existing systems.

### BRIEF DESCRIPTION OF THE INVENTION

The disclosed subject matter will forever change the nature of research and development for products. Currently there is no universal system to compare a product inside the universe of all products under consideration, for a demographically related emotional response elicited in the recipient of the product. Traditionally, a perfume manufacturer would compare its perfume to other perfumes or colognes; however, with the disclosed subject matter, the perfume manufacturer would also have the ability to compare its perfume against other products which evoke similar emotional responses in the recipient (e.g. jewelry, flowers, lingerie, etc.). The perfume manufacturer could then repackage or redesign the perfume to gain ground on those “competitive” purchases (e.g. make the perfume bottle look more like jewelry or crystal). Further, this can make identifying the elasticity of the price buyers are willing to pay within a particular demographic and emotional “band” significantly easier, consequently allowing the perfume manufacturer to change its price structure. In a general sense, the disclosed subject matter provides product manufacturers access to different product development directions because the disclosed subject matter helps manufacturers gain additional insight into the rationale of purchase decisions made by buyers.

The foregoing is accomplished by creating a method/system to easily score user satisfaction data based on the emotion elicited in the recipient—the “emotional value” the product carries in a particular demographic and permitting the products and services to be selected based on this emotional value. The method/system aggregates and measures the emotional effect a product or service will have on a particular demographic and present this emotional effect in an easy to use way for the public at large. This solution will help ensure a particular product will satisfy both the purchaser's and recipient's emotional goal.

For example, a Husband wants to buy a gift for his Wife to lift her spirits after a difficult time. Until now, the only data the Husband had available to him is his known experience—i.e. the Husband has purchased the same product or service for his Wife in the past. Spending hours entering a variety of items in the search box the Husband still may select an item and be greeted with a lukewarm response from his Wife. Consequently, neither the Husband nor the Wife received the positive emotional benefit expected from the purchase. In another example, with this solution, grandparents can enter their grandson's demographics and be provided with a large list of gifts that have proven to satisfy this demographic from which they can add their knowledge of their grandson to select the gift that causes him great satisfaction.

Web-based e-tail stores flourish on the Internet. According to Forrester, by 2014 the web will directly account for 8% of U.S. retail sales and influence 53% of consumer purchases. Currently e-tail stores carry hundreds of millions of products. Amazon offers more than a billion product choices. This process will help buyers make less stressful, easier, more informed purchase decisions from a greater variety of options and help avoid disappointment with product/service choices.

### SUMMARY OF THE INVENTION

One purpose of the Emotional Value Ranking System™ (EVRS™) (both trademarks of AvaTrends, LLC) is to simplify a very common purchase desire: the desire to change a person's emotional state. It allows the buyer to input the desired emotional outcome of the recipient upon receipt of the product or service. The buyer is provided with the products and services that are recommended by the product's creator and by previous customers to have the same reported emotional value attached to the product.

In one example, a buyer may desire a purchase to cheer up a sad friend. The buyer would select the emotional characteristic “cheer” and would be presented with a number of products and services designed and/or reported by previous purchasers/recipients as eliciting cheer in the recipient. In an alternate example, a buyer may desire a product that encourages them during a trying period of time. The buyer would select “encourage” and would be presented with a variety of products and services designed by the manufacturer to encourage and/or reported by previous purchasers/recipients as encouraging them.

At the core of any product's brand identity is some emotional value. The American Marketing Association defines a brand as a “Name, term, design, symbol, or any other feature that identifies one seller's good or service as distinct from those of other sellers.” One key distinction within a brand of a product or service is the emotional value it provides the recipients. One purpose of this system/method is to trade or transact business based on that emotional value. This brings “brand” closer to a person's desired emotional outcome minus the particulars of the product or service. Many buyers want to purchase a good or service based on the desired emotional outcome for themselves or the recipient of the product or service and the particulars of the product or service is of less interest. E-tail shopping becomes easier as the buyer can hone in on the desired emotional outcome without going through mental gyrations as to, for example, which product will better cheer up a person: a lively music CD, a bouquet of flowers or a new hat? The EVRS™ relies on the intent of the maker, the frequency of purchases by other people and the reported emotional impact/outcome from users who have purchased and/or received each item.

This “value” will carry over into the advertising pricing scheme. Manufactures desire to quantify that the dollars they spend on advertising results in brand awareness and ultimately, increased sales. Using an e-tail website search now returns a few products in sponsored advertisements or banner advertisements followed by sometimes hundreds of products from each query. The search engine fees paid to the owner of the search engine stay low because of the low conversion/sale rate (e.g. the difficulty of linking a product appearing in the search query with any of the buyer's desires for the purchase).

A big benefit of the EVRS™ is that as products improve in EVRS™ Score (EVRSS™) (a trademark of AvaTrends, LLC) the buying predictability will also improve. A product or service that has a high EVRSS™ will have the larger advantage over similar products that have lower EVRSS™. Once this value is quantified, it can be transferred from the e-tail store advertising to any other marketing effort of the manufacturer—similar to the way the Good Housekeeping Seal™ (a trademark of Hearst Communications, Inc.) becomes part of the marketing effort for a product. The higher the EVRSS™ the more likely the product will be purchased. This value could then be translated into higher prices for the advertising and banners purchased by the manufacturer. An additional value of the EVRS™ is that manufacturers can review the scores of their products and the emotional ranking score reported by the recipients to understand more about what customers value in the manufacturer's products. The EVRS™ simplifies something that manufactures struggle to understand at this time: “what is going on in the head of a potential buyer before they purchase my product?” Knowing this information provides the manufacturer with valuable information about new features for the product, product changes or even additional product derivation.

According to an exemplary embodiment, a method of scoring the emotional value of a product or service is shown. This method collects the desired emotional value from the manufacturer/service provider which is stored with the product in the e-tail inventory database. If the product's emotional value isn't known, that value can be appraised from past purchasers of the product or service. That emotional value characteristic is used in conjunction with other characteristics including frequency of purchase and additional feedback from customers. This allows products to be segmented by the kinds of emotions they offer and ranked against all products and services that offer a similar emotional value.

According to a second exemplary embodiment, a method of delivering products and services to buyers based on the desired emotional state of the buyer. The buyer informs the system of their desired emotional state after the purchase and receipt of the product, and the system responds with all products that are designated to deliver that emotional response. The products could be ranked by popularity, including which is selected most often generally, which is selected most often to elicit the desired emotional response, which is reported as eliciting the desired emotional response upon actual receipt, etc.

According to a third exemplary embodiment, a method of dynamically setting advertising prices is shown. The method includes using the EVRS™ to establish advertising prices because the higher rank offers a clearer return on investment (ROI) on the dollars spent on the advertisement. If an advertisement has a 100% sales response rate, that advertisement is more valuable than an ad with a lower response rate. Knowing the desired emotional state of a buyer before their purchase increases the value of advertisements directed to products or services which elicit the desired emotional response thereby increasing the likelihood of a purchase. This also has the additional benefit of lowering the return rate for products (e.g. if the recipient likes the product or service because it elicits the desired emotional response, it is significantly less likely that the purchaser or recipient will return the purchase).

This summary and the following detailed description are directed to certain specific embodiments of the invention. The invention is not limited to the particular embodiments and applications described herein. The invention is defined only by the claims.

### BRIEF DESCRIPTION OF THE DRAWINGS

FIG. 1 is an illustration of one embodiment detailing a simplified purpose of the invention.

FIG. 2 is an illustration of one embodiment of the color codes for emotional descriptors and examples of the specific emotional responses to a product that could be associated with each color.

FIG. 3 Components of the interaction between users and the system.

FIG. 4 is an illustration of one embodiment of the product coding process.

FIG. 5 is a list of one embodiment of negative emotions which could be employed for surveying the buyer of the product and/or the end user of the product.

FIG. 6 is an illustration of a web-based interface that allows a user to select different emotional outcomes for different classes of users, by gender, by age, etc., according to an exemplary embodiment;

FIG. 7 is a chart of the emotional state scoring elements.

FIG. 8 is an illustration of a web-based interface that allows a user to score emotional outcomes by comparing before and after feelings, according to an exemplary embodiment;

FIG. 9 is a chart illustrating an exemplary embodiment of a product database with scores.

FIG. 10 is a chart illustrating the aggregate desired emotional outcome score according to an exemplary embodiment.

FIG. 11 is a diagram that illustrates the aggregate emotional scores stored in a database attached to the e-tailer's product inventory database, according to one exemplary embodiment.

FIG. 12 is an illustration of the flow of information between a user, the e-tail web site, the inventory database and the emotional score aggregation according to one exemplary embodiment.

FIG. 13 is an illustration of the information stored by the e-tail vendor which could include information about the inventory, the emotional ranking score and the advertisements and associated advertisement data, according to one exemplary embodiment.

FIG. 14 is an illustration of the process to dynamically score the emotional value of each product purchased and filter such that scores are only included when the product delivers the right emotional response, according to one exemplary embodiment.

FIG. 15 is an illustration of the process to dynamically price advertisements according to one exemplary embodiment.

### DETAILED DESCRIPTION

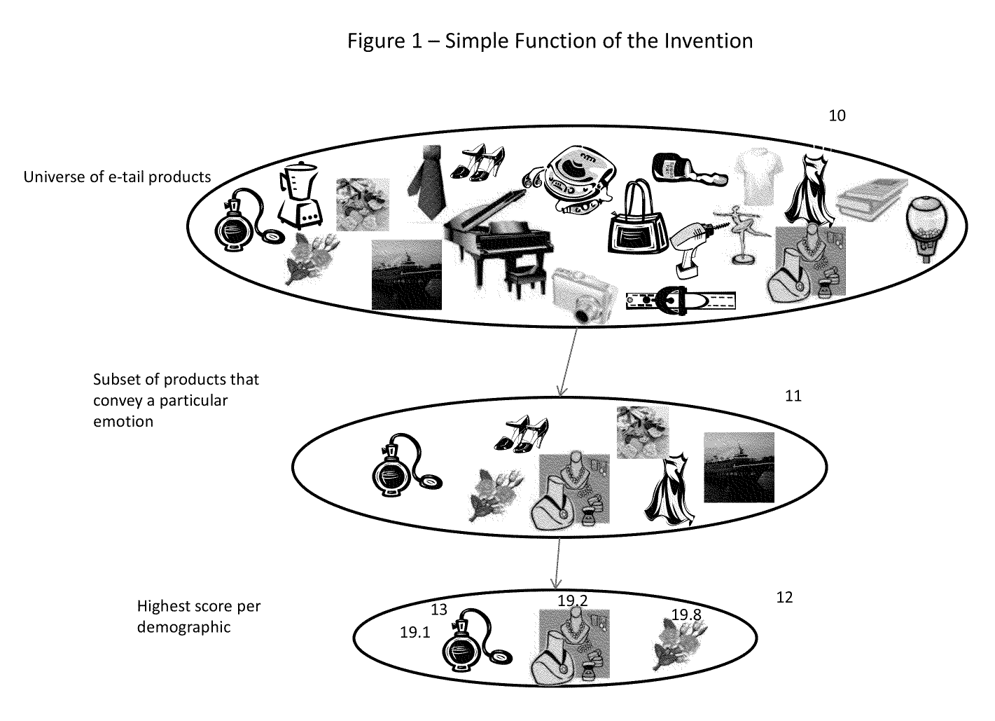

FIG. 1 is an illustration of one embodiment detailing a simplified purpose of the invention. According to this embodiment, an e-tail vendor potentially has millions of products in inventory 10. The first portion of this solution is the categorization function—literally categorizing products by the emotion evoked when a recipient receives the product. The next feature of the solution occurs as the e-tailer's search engine creates a subset of products 11 for the buyer which convey the particular emotion the purchaser hopes the recipient feels upon receiving the gift. In this particular example, romantic love is shown. From this subset of products, the buyer can see many products which convey the emotion they desire for the recipient. Lastly, the numeric score which aggregates the impact score from prior recipients who have received the product is displayed to the buyer. The numeric score helps to give the buyer confidence that the recipient will experience the emotional value the buyer hopes to convey 12. In this particular example, perfume has a score of 19.1, jewelry has a score of 19.2, and flowers have a score of 19.8.

In a more complex embodiment, the ranking could account for the recipient's demographics. To explain a bit further, a particular product would have a different EVRSS™ for a 16 year old female than for a 40 year old male. In yet another embodiment, the demographic of both the recipient and purchaser could be taken into account. For example, a 50 year old male purchasing something for his 30 year old daughter would want a different listing of products than if he was purchasing something for his 30 year old girlfriend. Regardless of the particular embodiment, all of these aim to reach the same goal—reduce the chance of purchasing a product or service that is poorly received. These more complex embodiments are discussed in further detail below.

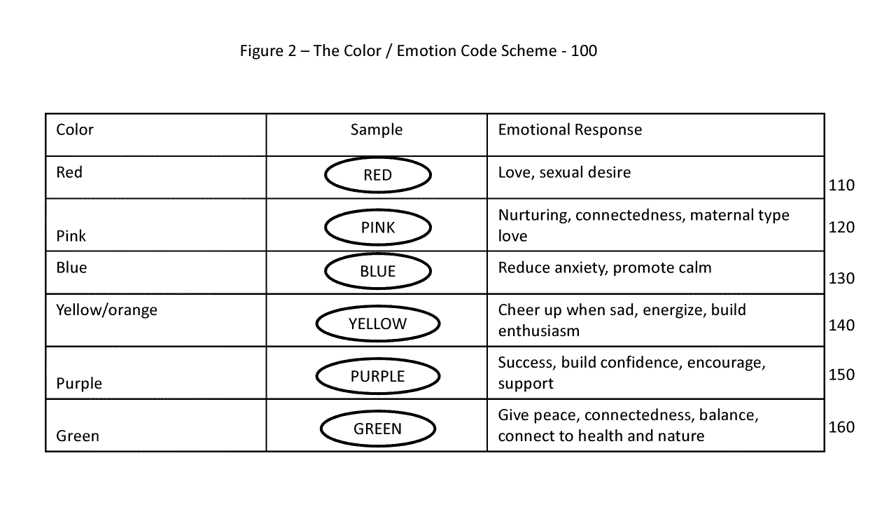

FIG. 2 is an illustration of one embodiment of the color codes for emotional descriptors and, examples of the specific emotional responses to a product that could be associated with each color 100; the color code makes the system easier to understand and use. The color scheme in this particular embodiment contains colors that associated with certain psychological emotional states. In one embodiment, buyers could simply look for this universal color code on the label or price tags of products in a brick and mortar retail store or in the product description for an e-tail store. According to this embodiment, buyers that wish to covey romance 110 would seek the red indicator for romantic love as the emotion contained in the product purchase. In this embodiment, brotherly love or nurturing love would be conveyed by the color pink 120. The color blue would convey a calming emotion 130; the color yellow would convey emotional that cheers a recipient 140; the color purple would be the color of encouragement 150 while connectedness to nature would be conveyed by the color green 160. It is important to note that other colors could be employed as well as additional granularity could be achieved by further subdividing the psychological emotional states and associating those additional psychological emotional states with additional colors.

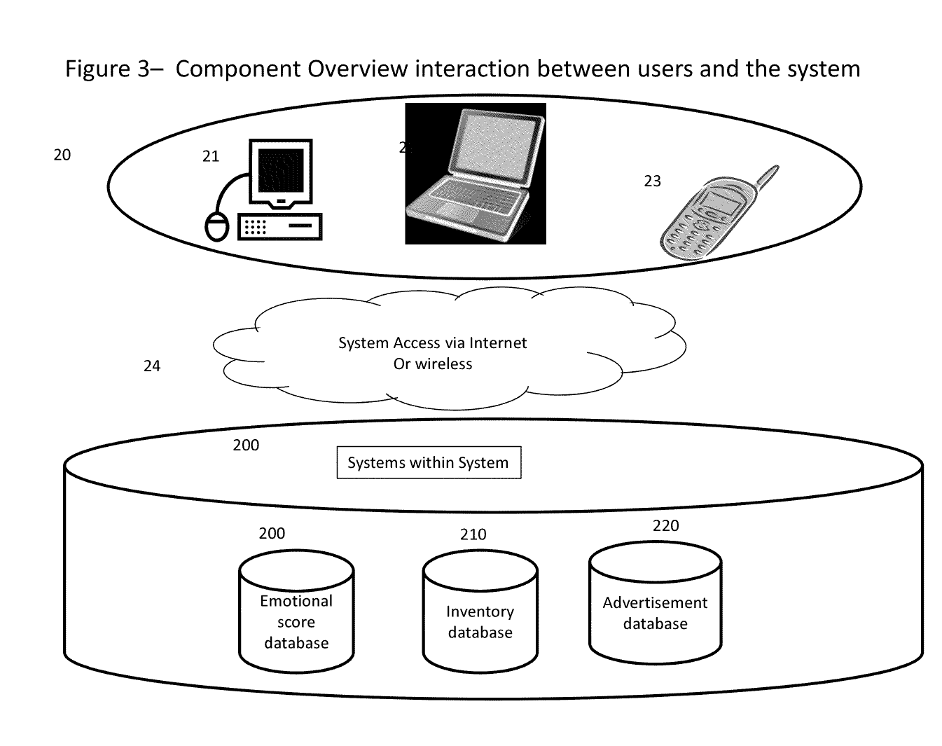

FIG. 3 defines each of the interaction between the users and the computer servers within the e-tail store. The user accesses the e-tail store through a computer device 20 which could include a PC 21, laptop 22, cellular/smart phone 23, tablet, or other communication enabled device. The user would connect to the e-tail store via an available communications medium such as the Internet or Wi-Fi 24. The user would submit their desired emotional value (e.g. cheer, love, etc.) via the communications medium to the e-tail store. The e-tail store would search an inventory database 210 which contains all the products and services offered for sale and an associated emotional score database 200 to identify the particular products and services which most closely match the user's indicated emotional value (e.g. the emotional response the user/purchaser desires to evoke in the recipient). Additional databases could include an advertisement database 220 which contains and manages advertisements which are displayed on the user's screen as they shop at the e-tail store. Although discussed as three databases, one or more of the foregoing could be implemented in one or more databases as the particular needs of the e-tail store dictate.

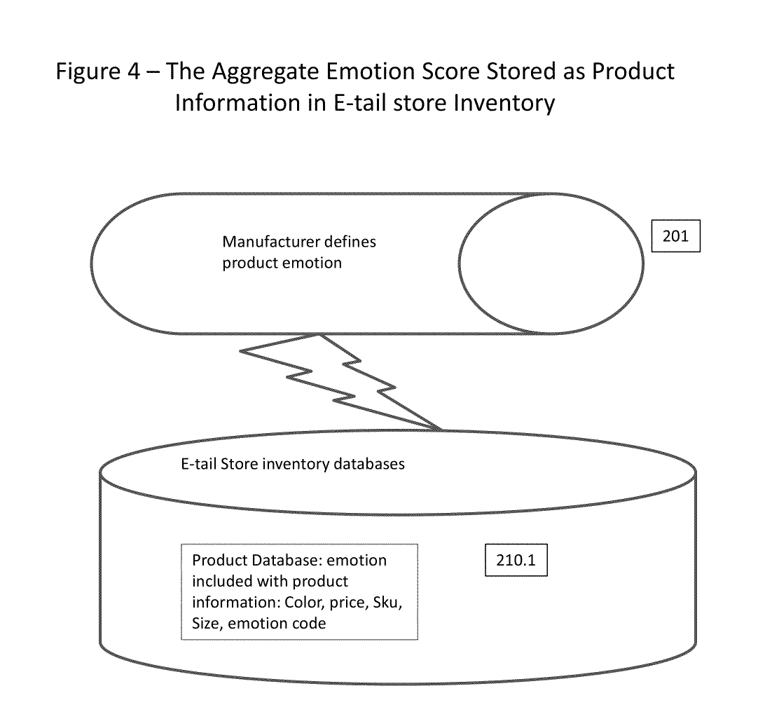

FIG. 4 is an illustration of one embodiment of the product coding process. The manufacturer 201 selects the emotional effect the manufacturer believes a recipient would receive from the product or service for each product or service that is sold into the retail and e-tail channel. The retail distributor then adds the emotion code to its inventory in the product database as it does other product information 210.1.

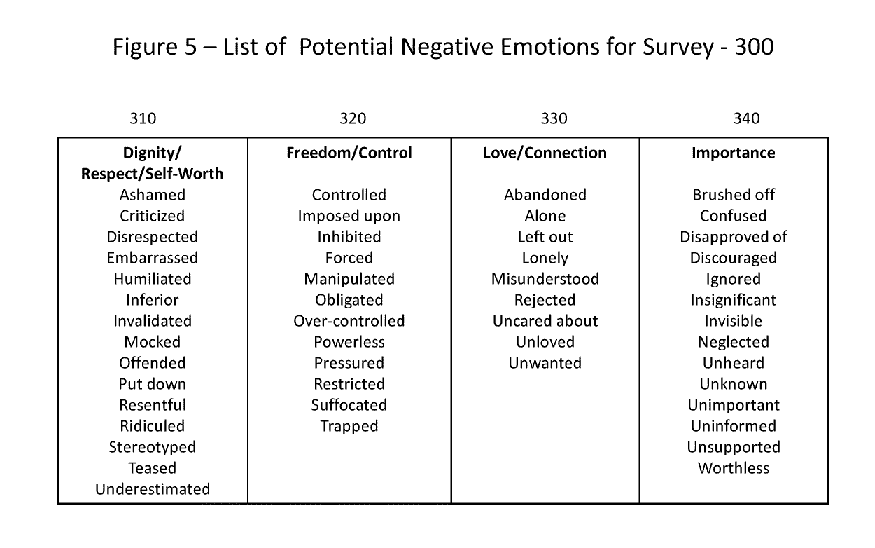

FIG. 5 is a list of negative emotions 300 which would be overcome through one or more product purchases according to one embodiment of the disclosed subject matter. Because the buyer may desire for the recipient to have a positive emotion once they receive the item purchased, the buyer could use any information about the negative states of the recipient as input prior to the purchase. Some categories of negative emotions in this embodiment include: Dignity Emotions 310 such as feeling embarrassed or humiliated. Negative emotions associated with freedom and controls 320 are powerless, pressured and trapped. Some of the negative emotions attached to love and connection 330 are rejected, misunderstood and lonely. Some of the negative emotions attached to importance 340 are insignificant, neglected, and unimportant. By selecting the negative emotion, the system could provide products or services that counteract the negative emotion.

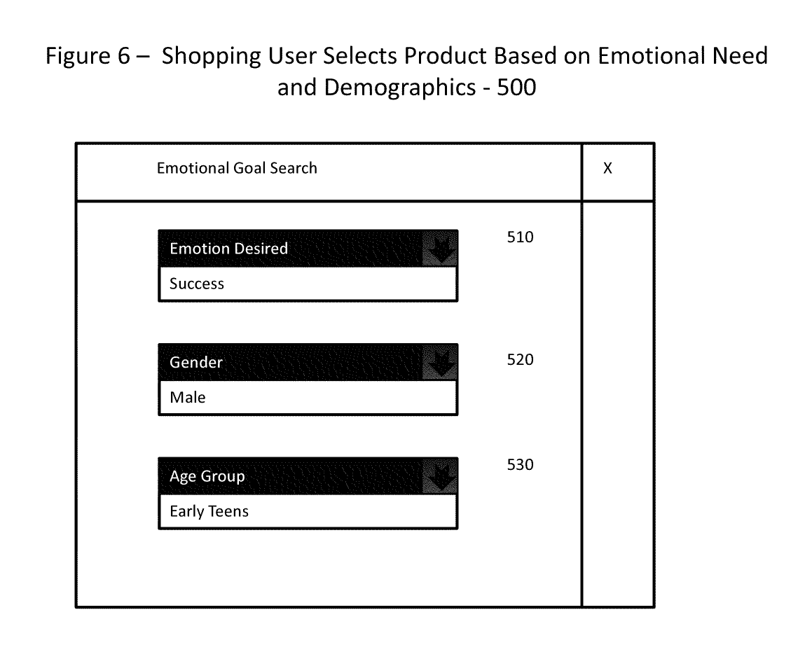

FIG. 6 is an illustration of a web-based interface that allows a user to select different emotional outcomes for different classes of users, by gender, by age, etc., according to an exemplary embodiment. Currently a buyer has to guess which product out of all products that are in the particular vendor's inventory (including products available through a particular e-tailer's website offered for sale by other merchants), which products will bring about the most desired emotional value to the recipient. Through a simplified user interface 500, the buyer has the opportunity to select the emotion desired for the recipient 510 and some of the demographic information 520, 530 about the recipient. The system then returns to the buyer products available from the e-tail store that have been given the highest aggregate score for that emotion for that demographic information. Clearly, other demographic information could be included, such as geographic location, religious affiliation, hobbies, sexual preference, height, weight, dietary constraints, allergies, etc.

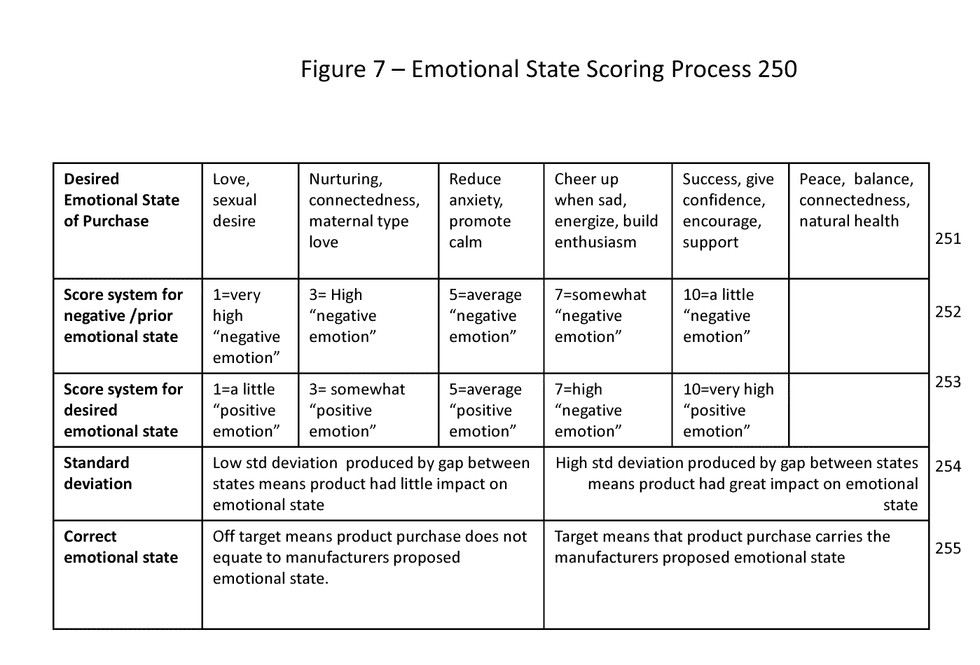

FIG. 7 is a chart of the definitions for each element of the emotional state scoring 250 for the products available from an e-tail entity according to an embodiment of the disclosed subject matter. The first category is the Desired Emotional State of Purchase 251. This field describes the emotion that the purchaser desires to evoke in the recipient when the recipient receives a product. The next category is the score applied to the negative or prior emotional state of the recipient 252. This score measures the initial negative emotional state of the recipient which buyer is supposed to positively impact with the purchaser. To put this another way, this score is the relative level of the recipient's negative emotional state prior to receiving the purchase (e.g. the recipient could be very anxious; a little sad; etc.). The next category is the positive emotional score the recipient experiences after having received the product 253. To put this another way, this score is the relative level of the recipient's positive emotional state after receiving the purchase (e.g. very loved; mildly calmer; etc.). The next category of information is the standard deviation between the negative or prior emotional state score and the positive or receiving emotional state score 254. The purpose of the score is to show the delta of the impact on an emotional state. For example, a recipient with a negative emotional state of very sad that receives a purchase which changes their emotional state to very happy has a large impact on the recipient's emotions. Conversely a negative emotional score of 3 which moves to a positive emotional score of 1 shows less impact on the emotional state of the recipient. The category called correct emotional state tracks the emotional state the manufacturer believes should occur when the product is received vs. the emotional state that actually occurs when the recipient is queried as to the emotional state the product evoked in the recipient when the product was received by the recipient 255. It is intended that other emotional states, scoring levels and/or descriptors, and statistical analyses could be employed and remain within the scope of this disclosure.

As an example of how this data might be used, assume the purchase was for a necklace with a heart on the chain. The manufacturer may declare the appropriate emotional state for the recipient is romantic love. However if most of the purchases of this particular necklace are for one's children, then the desired emotional impact as stated by the manufacturer does not match the intent of the purchase, which would likely be nurturing. This is very useful information for the manufacturer and the e-tail store. A customer perceives a product in a way that is different from the manufacturer's intention. At this point the manufacturer can change that type of emotional impact of his product, change the product name or packaging or make other changes so that a manufacturer is clear on the most likely desire for the purchase of the product. Additionally or alternatively, the manufacturer could redirect advertising funds towards alternate markets.

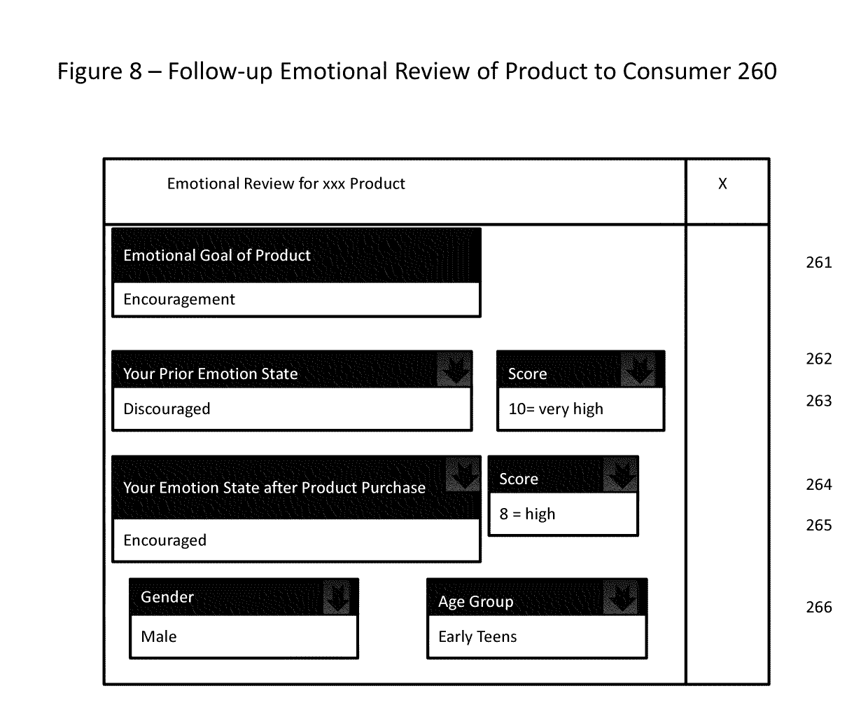

FIG. 8 is an illustration of a web-based interface 260 that collects recipient information after the recipient has actually received the product according to an embodiment of the disclosed subject matter. Here it is called a Follow-up Emotional Review of the Product. The recipient's initial emotional state 262 and a measurement of this state 263 prior to receiving the product are collected. The next piece of information collected is the recipient's emotional state after receiving the product 264 and 265. Demographic data 266 is then collected so that the emotional impact is known by gender and relative age of the recipient, according to an exemplary embodiment. As mentioned earlier, this is a simplified example requesting only rudimentary demographic information. It is intended that other demographic information could also be requested and stored to provide more accurate product and service listings and suggestions. In one example, a unique number could be included with the product or service (e.g. on the shipping receipt, etc.). This has the advantage of identifying not only the particular product or service provided to the recipient, but also could allow the demographic and emotional info entered by the purchaser to be matched with that of the recipient.

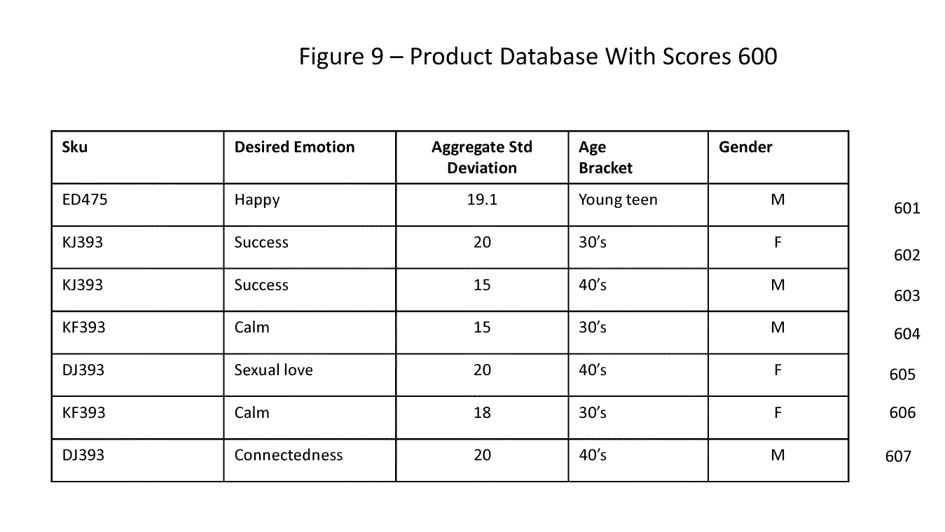

FIG. 9 is a chart illustrating an exemplary embodiment of aggregate emotion score as it is stored along with product/inventory information 600. The inventory system for an e-tail store typically contains a variety of information about each product. For example, one inventory database would contain the product name, the manufacturer, the SKU number and the product's price which are all pieces of information that describe the particular product. Other databases track information on the status of products such as inventory levels, shipping information, order processes and timeframes, etc. The emotional value and aggregate score for each product would be stored in a database similar to the above. The example database contents illustrated in this exemplary embodiment tracks the particular emotion conveyed and the aggregate score for every product in the e-tail store's inventory. The product in inventory ED475 scored very high, 19.1, meaning that teen aged males who received the product rated it as having a large impact on them (e.g. making them very happy) 601. The next product QKJ 393 received higher impact scores from females who are in their 30's 602 versus males who are in their 40s 603. The product identified as KF393 is scored as having more impact on females 606 in their thirties then on males in their thirties 604. The product identified as DJ393 had very high scores for both females 605 in their 40's and men in their 40's 607, but for different desired emotions.

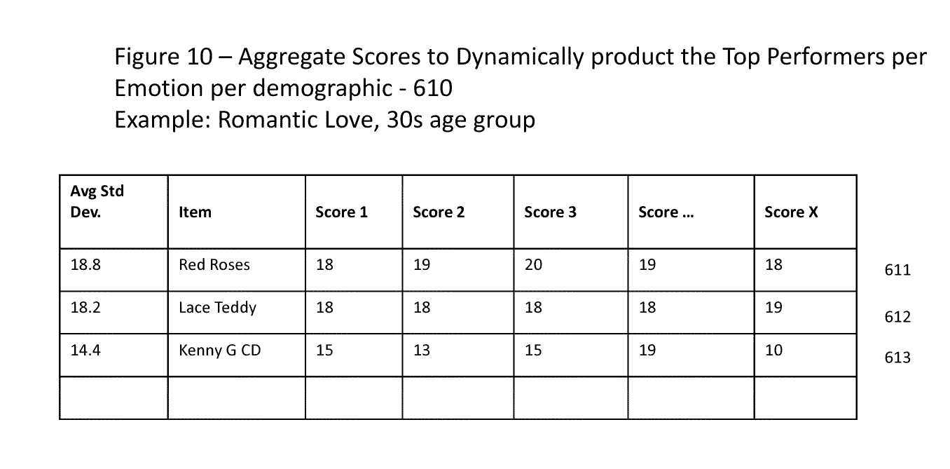

FIG. 10 is an exemplary chart illustrating aggregating the desired emotional outcome score 610 so that the products with the highest emotional change score are the products presented when a user is searching for a particular emotion in a particular demographic group. In this example, the user is searching for products that elicit romantic love for people in the 30s age group. The database collects the scores of all products that are noted by the manufacturer, and/or reported by recipients, as delivering the emotion of romantic love to the recipient. Note that the scoring system can use the standard deviation between the negative emotions and the positive emotions of the recipient to inform buyers as to which of these gifts offers the most impact in conveying romantic love for a particular age group. The red roses carry the highest score 611 while a teddy carries a similar but slightly lower impact score 612. A buyer could deduce from these scores that either of these gifts would have a similar impact on the recipient. The buyer can then supplement the scoring with the buyer's own knowledge of the recipient to further narrow down the selection from the top scoring products (e.g. the buyer may know that the recipient is allergic to roses or prefers to sleep in tee shirts vs. a lace teddy). Regardless, the buyer has real assurance of the emotional impact regardless of the actual selection made. A buyer can also note that when given the choice of a Kenny G CD 613 or red roses, the red roses are the safer bet to elicit romantic love in the recipient.

One benefit of the scoring system is that it provides the user with a better understanding of the impact of the gifts they select for a recipient. But more than this, the scoring system enhances the shopping experience because the buyer is informed of high scoring products from the collective of everyone who has shopped for a gift for this demographic. The buyer should see many gifts which carry a great deal of emotional impact of which they may be completely unaware. With this, a Husband could have many successful surprises for his Wife over the course of their marriage. As his Wife ages, his gifts are continually refined and tailored through the emotional impact for her demographic.

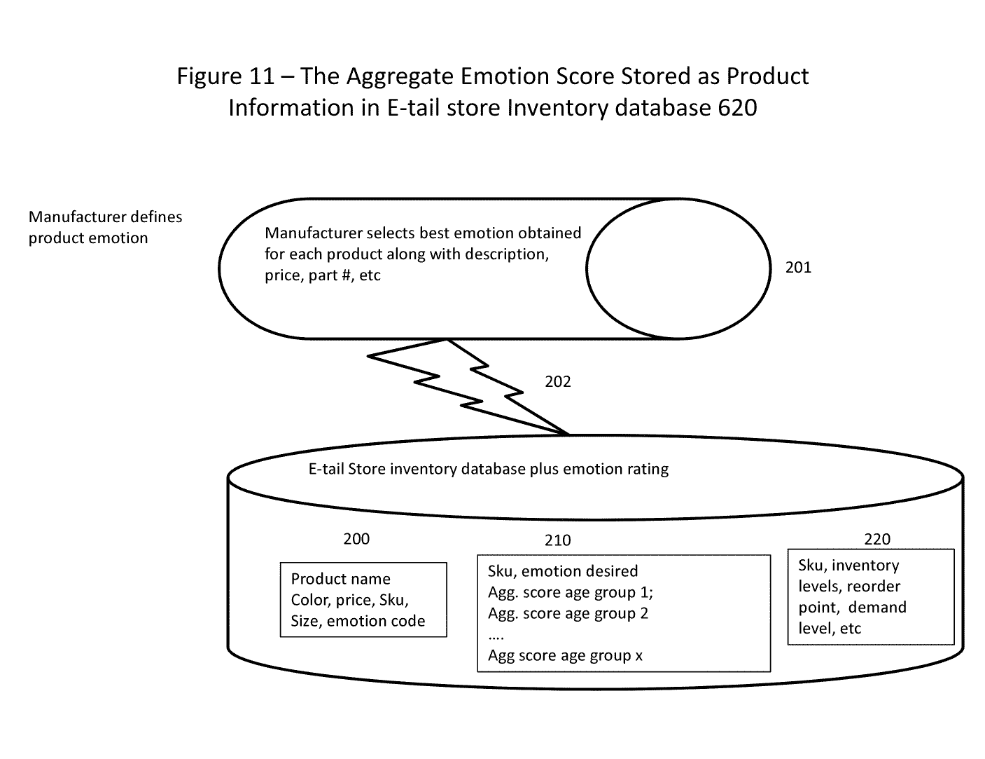

FIG. 11 is an exemplary diagram that illustrates the physical server systems that could create and track the emotional scores from the point of the manufacturer to the inventory of an e-tail store 620. When a product is manufactured, the manufacturer could select the initial emotion value such as calm, romantic love, comfort, etc. which is attached to that particular product in the same way the manufacturer defines the description, the size, the manufacturer's suggested retail price and the cost of the product 201. In one embodiment, the manufacturer could select multiple emotional values for different demographics. This information is transmitted 202 to e-tail store's databases that manage the store's inventories such as a product database 200 and the supply chain and ordering information database 220. Another database could track each product's emotional score as the same is associated with the recipient's Follow Up Emotional Review of the product 210.

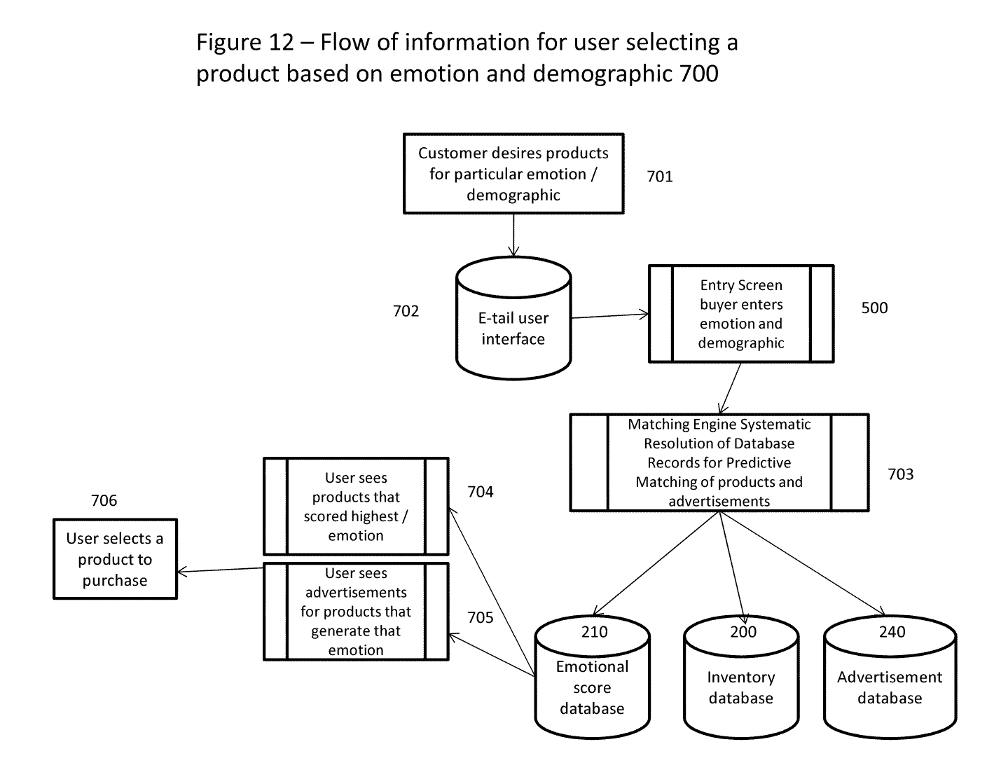

FIG. 12 is an exemplary illustration of the flow of information between a user, the e-tail web site, the inventory database and the emotional score aggregation 700 according to an embodiment of the disclosed subject matter. In this exemplary embodiment, a buyer desires to purchase a product which will evoke a particular emotion to the recipient of the product 701. The ordering system from the e-tail store provides an online interface that allows the buyer to enter some demographics about the recipient such as the age and sex and the emotion the buyer would like the recipient to have upon receiving the product (e.g. a feeling of success or a feeling of being nurtured) 500. A search engine takes the information entered by the buyer and searches the e-tailer's inventory databases 200 and 210 identifying and ranking all products that have scored the highest for the emotional response the buyer is seeking for the demographic group indicated. Additionally the search engine connects to the advertising database to identify advertisements geared towards the buyer's entered demographic and desired emotional response 240. The buyer sees products that scored highest for the emotion and demographic entered 704. The buyer also sees advertisements which are geared to the desired emotion for the entered demographic 705. From this group the buyer selects the item for purchase 706.

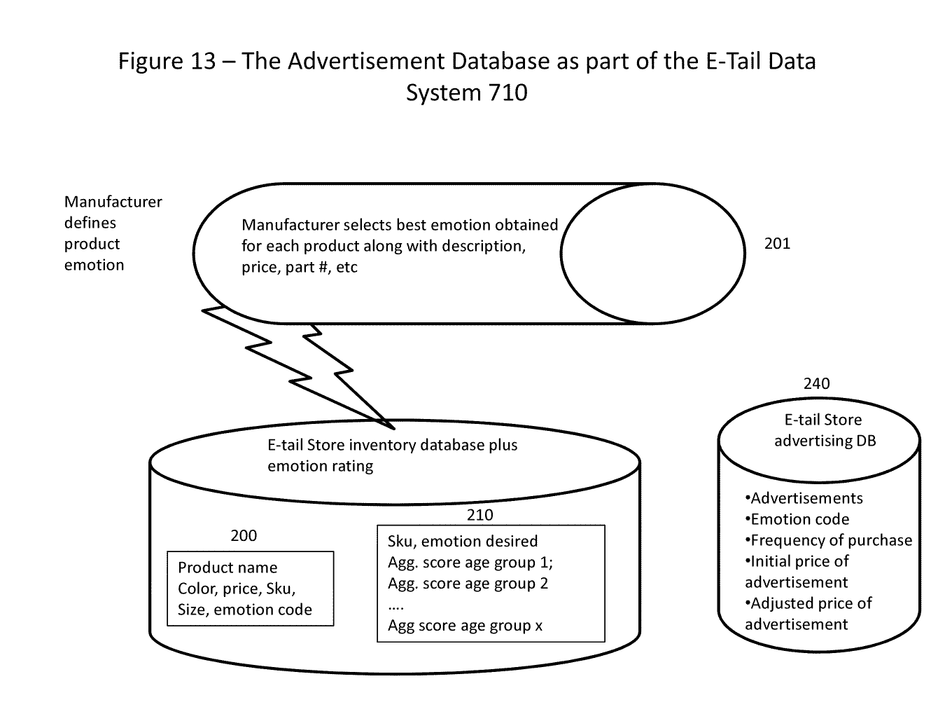

FIG. 13 is an exemplary illustration of the physical server systems 710 that manage inventory 200, manage the emotional score collection and the advertisements that correspond to emotional values. The initial emotional score for each product is assigned by the manufacturer 201 and is stored with the inventory information within the e-tailer's databases. The advertising database 240 keeps track of various data concerning advertisements that are displayed in the e-tailer's website, such as which emotion and demographic the advertisement is targeted towards, the base cost of the advertisement and the adjusted cost of the advertisement. The price for the advertisement will evolve based on the advertisement's conversion to sales percentage. The higher the conversion to sales percentage is, the higher the return on investment to the advertiser is and the more useful the advertisement will be for a manufacturer; therefore, as the conversion to sales percentage increases, the cost of the advertisement also increases.

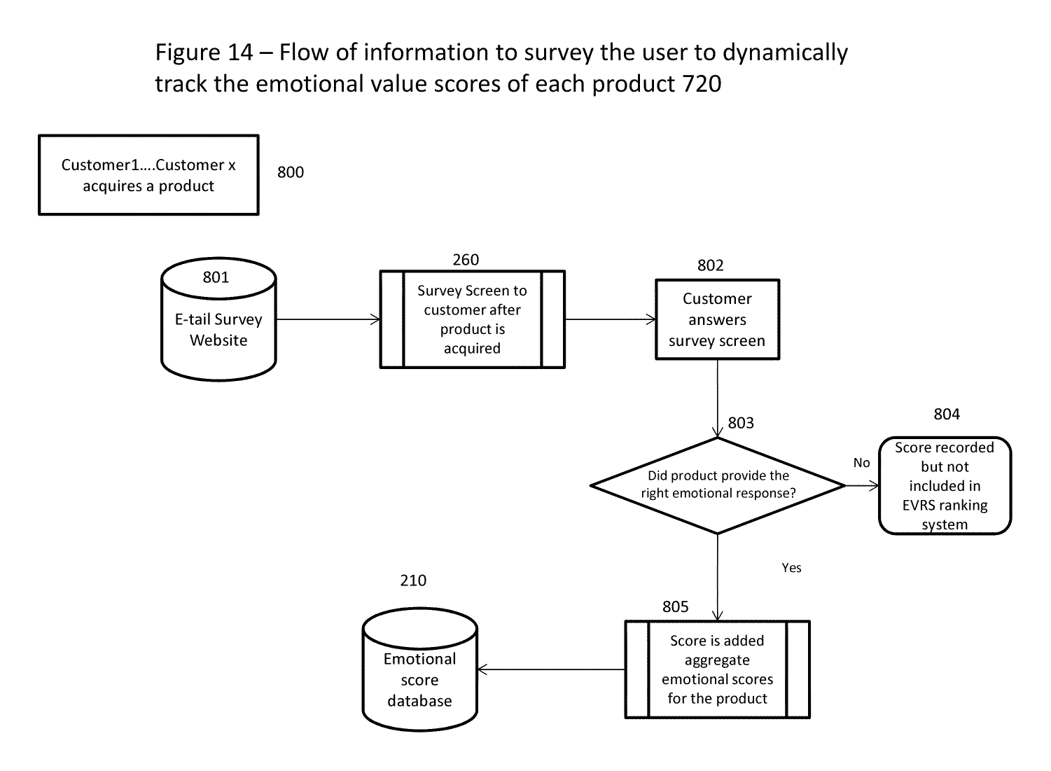

FIG. 14 is an exemplary illustration of the process to dynamically score the emotional value of each product purchased. It becomes important to be able to track that a product actually delivers the desired emotional response to the recipient to ensure the aggregate emotional value scores are meaningful and accurate. For this reason, a filter is put into place which eliminates the emotional impact score for the wrong emotion. The process is as follows Customers1 . . . CustomersX all acquire a product 800. The e-tail store provides a survey to customers who have received the product in an effort to ascertain the emotional state each customer experienced and the emotional impact score each customer experienced 801. The customers complete the survey and the information is received by the e-tail store 802. An application within the e-tail stores ordering and surveying system 803 determines whether the product elicited the predicted emotional response in the recipient. In one embodiment, if the recipient does not respond with the predicted emotion, the emotional impact scores are not included in the aggregate emotional value ranking system scores for the product 804. If the emotion experienced by the recipient is the correct emotion, that customer's emotional value impact score is added to the aggregate emotional scores for that product 805. These aggregate scores are further classified per the demographics of the recipient and are recorded in the emotional store database 210. In an alternate embodiment, if the recipient does not respond with the predicted emotion, the manufacturer's original predicted emotion will eventually be superseded by the actual emotion that was evoked in the recipient and reported on the survey. This embodiment has the advantage of being adaptive to the actual emotional response as opposed to relying heavily on the manufacturer's belief.

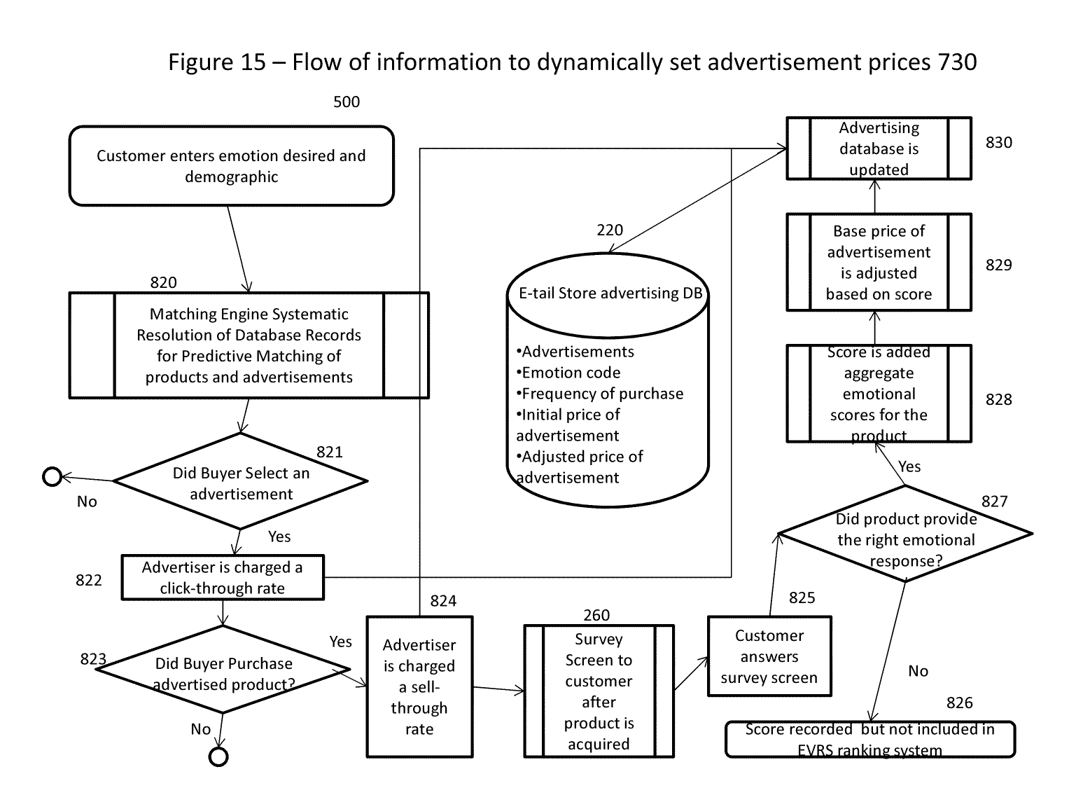

FIG. 15 is an exemplary illustration of the process to dynamically price advertisements and illustrates how user surveys also affect advertisement pricing 730. To recap briefly, as a user searches for a product that elicits a certain emotional response within a certain demographic, the disclosed subject matter provides both a listing of products which meet the user's criteria and advertisements for products that meet the user's criteria. The advertisements are chosen by the disclosed subject matter similarly to the products that are shown—the higher the emotional value score of the product advertised, the more often that particular advertisement will be shown in response to the search criteria (e.g. desired emotion and demographics). Because the advertisements are geared to meet the user's particular emotional goal for the chosen demographic, there is an increased likelihood the advertisement will result in a purchase. A high frequency of advertisement that leads to purchase and a high emotional score ranking creates a higher ROI on the advertisement and therefore becomes a more valuable advertisement. The process of dynamically pricing advertisements is as follows. A buyer desires a product that will evoke a particular emotion in the recipient. The ordering system from the e-tail store provides an online interface that allows the buyer to enter some demographics about the recipient (e.g. age and sex) and the emotion the buyer would like the recipient to have upon receiving the product (e.g. a feeling of success or a feeling of being nurtured) 500. The e-tail store's search engine searches its inventory database and its advertisement database 820 and returns the products with the highest aggregate score within the Emotional Value Ranking System™ for the entered demographic and some advertisements from the advertisement database. The e-tail store's search engine selects the advertisements that are also associated with the specific emotion and demographics entered. An advertisement that is selected by the buyer 821 is charged a click-through rate 822 which is entered into the advertisement database 220. This means that the advertisement caught the attention of the user and the advertiser received value. Next the application 823 determines if the user purchased the advertised product. If the user purchases the advertised product 824, the advertiser receives more value from the advertisement and so is charged the sell-through advertisement rate 824 which is noted in the advertisement database 220. The recipient is sent a survey after the product is received 260 to ascertain the emotional value the recipient received from the product and to score its emotional impact. If the recipient does not respond with the predicted emotion, the emotional impact scores are not included in the aggregate emotional value ranking system scores for the product 826. If the emotion experienced by the recipient is the correct emotion 827, that recipient's emotional value impact score is added to the aggregate emotional scores for that product 828. The base price of the advertisement is adjusted once more based on the product having the right emotional response 829. Other embodiments related to product scoring could also be implements with respect to updating the advertising emotional value. Finally, the advertising database is updated with the new price for the advertisement 220.

What is claimed is:

1. A method, the method comprising the following steps:
receiving a desired emotional state from a purchaser, wherein said desired emotional state is the desired emotional state said purchaser desires to evoke in a recipient, wherein said desired emotional state is received via a communications medium;
searching a database of products and/or services to identify products and/or services expected to evoke said desired emotional state, said database of products and/or services stored on a computer readable medium;
transmitting information associated with said identified products and/or services to said purchaser, said information including general information for each of said identified products and/or services and an emotional value score for each of said identified products and/or services, said emotional value score based on the likelihood that each of said identified products and/or services will evoke said desired emotional state in said recipient when said recipient receives said product and/or service;
permitting said purchaser to purchase one or more of said identified products and/or services for said recipient.

2. The method of claim 1, additionally comprising the following steps:
receiving recipient demographic information from said purchaser, said recipient demographic information relating to said recipient and received via said communication medium, wherein said recipient demographic information includes at least a gender and an age range; and
wherein said emotional value score is also based on said recipient demographic information.

3. The method of claim 2, additionally comprising the following steps:
receiving purchaser demographic information from said purchaser, said purchaser demographic information relating to said purchaser and received via said communication medium, wherein said purchaser demographic information includes at least a relationship indicator, said relationship indicator indicating said purchaser's relationship with said recipient; and
wherein said emotional value score is also based on said purchaser demographic information.

4. The method of claim 3, additionally comprising the following steps:
providing a survey to said recipient, said survey related to at least one of said products and/or services purchased for said recipient by said purchaser;
receiving responses from said recipient via said communications medium, wherein said responses include at least:
an initial emotional state of said recipient, said initial emotional state the emotional state of said recipient before receiving said purchased products and/or services;
an initial emotional score of said recipient, said initial emotional score related to the intensity of said initial emotional state;
a post emotional state of said recipient, said post emotional state the emotional state of said recipient after receiving said purchased goods and/or services; and
a post emotional score of said recipient, said post emotional score related to the intensity of said post emotional state; and
adjusting said emotional value score associated with said post emotional state, said recipient demographics, and said purchaser demographics according to the difference between said initial emotional score and said post emotional score.

5. The method of claim 4, wherein said emotional value score is adjusted according to the standard deviation between said initial emotional score and said post emotional score.

6. The method of claim 4, wherein said survey is provided in response to receiving a unique identifier from said recipient via said communications medium, said unique identifier identifying at least said purchased goods and/or services, said desired emotional state, said recipient demographics, and said purchaser demographics.

7. The method of claim 1, wherein said emotional value score is generated with:
a purchase frequency, said purchase frequency the number of times a particular one of said products and/or services is purchased in response to said desired emotional state;
a query frequency, said query frequency the number of times said particular one of said products and/or services is one of said identified products and/or services; and
a delta amount, said delta amount the difference between:
an initial emotional state of said recipient, said initial emotional state the emotional state of said recipient before receiving said purchased products and/or services; and
a post emotional score of said recipient, said post emotional score related to the intensity of said post emotional state

8. The method of claim 1, additionally comprising the following steps:
searching an advertising database to identify advertisements for products and/or services expected to evoke said desired emotional state, said advertising database stored on said computer readable medium, wherein each of said advertisements in said advertising database is associated with at least one advertiser;
transmitting at least one of said identified advertisements to said purchaser, said at least one advertisement including said emotional value score for said products and/or services being advertised, said identified advertisements transmitted via said communications medium;
charging a price to each of said advertisers associated with at least one of said transmitted advertisements;
permitting said purchaser to purchase on or more of said products and/or services corresponding to said transmitted advertisement for said recipient.

9. The method of claim 8, wherein at least one of said advertisements is received from said associated advertiser with an expected emotional state, said expected emotional state the emotional state said associated advertiser believes the advertised product and/or service will evoke in a recipient.

10. The method of claim 8, additionally permitting said advertisers to query said advertising database to retrieve said emotional value score associated with at least one of said advertiser's products and/or services.

11. The method of claim 10, additionally receiving a modified advertisement from said advertiser, wherein said advertisement was modified in response to said retrieved emotional value score.

12. The method of claim 8, wherein said identified advertisements are also identified in a manner to maximize the amount charged to said advertisers.

13. The method of claim 8, additionally comprising the following steps:
providing a survey to said recipient, said survey related to at least one of said products and/or services purchased for said recipient;
receiving responses from said recipient, wherein said responses include at least:
an initial emotional state of said recipient, said initial emotional state the emotional state of said recipient before receiving said purchased products and/or services;
an initial emotional score of said recipient, said initial emotional score related to the intensity of said initial emotional state;
a post emotional state of said recipient, said post emotional state the emotional state of said recipient after receiving said purchased goods and/or services; and
a post emotional score of said recipient, said post emotional score related to the intensity of said post emotional state; and
adjusting the emotional value score of said purchased products and/or services according to said responses and if said purchase resulted from said transmitted advertisement, dynamically adjusting said price charged to said advertiser for said transmitted advertisement.

14. The method of claim 8, with the additional step of dynamically adjusting said price of said transmitted advertisement based on the number of times said transmitted advertisement is transmitted.

15. The method of claim 8, with the additional step of dynamically adjusting said price of said transmitted advertisement based on the number of times said purchaser interacts with said transmitted advertisement.

16. The method of claim 1, additionally comprising the following steps:
providing a survey to said recipient, said survey related to at least one of said products and/or services purchased for said recipient;
receiving responses from said recipient, wherein said responses include at least:
an initial emotional state of said recipient, said initial emotional state the emotional state of said recipient before receiving said purchased products and/or services;
an initial emotional score of said recipient, said initial emotional score related to the intensity of said initial emotional state;
a post emotional state of said recipient, said post emotional state the emotional state of said recipient after receiving said purchased goods and/or services; and
a post emotional score of said recipient, said post emotional score related to the intensity of said post emotional state; and
adjusting the emotional value score of said purchased products and/or services according to said responses.

17. The method of claim 16, wherein said emotional value score is adjusted only if said post emotional state matches said desired emotional state.

18. The method of claim 16, wherein said emotional value score associated with said post emotional state is adjusted according to the difference between said initial emotional score and said post emotional score.

19. The method of claim 16, wherein said emotional value score is adjusted according to the standard deviation between said initial emotional score and said post emotional score.

20. The method of claim 16, wherein said survey is provided in response to receiving a unique identifier from said recipient via said communications medium, said unique identifier identifying at least said purchased goods and/or services and said desired emotional state.
